(19) United States
(12) Patent Application Publication
(10) Pub. No.: US 2025/0022625 A1
(43) Pub. Date: Jan. 16, 2025

(54) COMPOSITE MATERIAL FOR NEUTRON SHIELDING AND FOR MAINTAINING SUBCRITICALITY, METHOD FOR MANUFACTURING SAME AND USES THEREOF

(71) Applicant: ORANO NUCLEAR PACKAGES AND SERVICES, MONTIGNY LE BRETONNEUX (FR)

(72) Inventors: Salma EL EUCH, PARIS (FR); Hervé ISSARD, VANVES (FR); Stéphane NALLET, LE MESNIL SAINT DENIS (FR); Angèle CARON, NEAUPHLE-LE-CHATEAU (FR)

(21) Appl. No.: 18/568,599

(22) PCT Filed: Jun. 8, 2022
(86) PCT No.: PCT/FR2022/051092

§ 371 Date: Dec. 8, 2023

(30) Foreign Application Priority Data
Jun. 10, 2021 (FR) 2106152

(51) Int. Cl. G21F 1/10; C08K 3/22; C08K 3/38; C08L 63/10

(52) U.S. Cl. CPC G21F 1/103; C08K 3/22; C08K 3/38; C08L 63/10; C08K 2003/2227; C08K 2003/387; C08K 2201/005

(57) ABSTRACT

A composite material for neutron shielding and for maintaining subcriticality obtained from a formulation including: 100 portions by weight of a composition including, the weight percentages being based on the total weight of the composition: from 30% by weight to 45% by weight of a thermosetting resin selected from a polyester resin and a vinylester resin, from 23% by weight to 58% by weight of an inorganic filler, the inorganic filler including at least one hydrogenated compound and at least one boron compound, and from 12% by weight to 32% by weight of a polyolefin or of an olefin copolymer; from 0.3 portion by weight to 1.4 portion by weight of a polymerisation initiator; and from 0.3 portion by weight to 1.4 portion by weight of a polymerisation accelerator. A manufacturing method to use this composite material.

### TECHNICAL FIELD

The present invention relates to a composite material for neutron shielding and for maintaining subcriticality which has particularly effective thermomechanical properties.

The invention also relates to a manufacturing method as well as to the use of such a composite material for neutron shielding and for maintaining subcriticality, in particular in the nuclear industry and, more particularly, as a part of a package intended for the transport, warehousing and/or storage of radioactive materials, in particular nuclear fuels.

### PRIOR ART

Composite materials for neutron shielding and for maintaining subcriticality which are used in the nuclear industry, in particular those which are intended for packages of radioactive materials, must have a certain number of properties so as to meet a complex specification which is required to ensure the safety of the transport, warehousing and/or storage of these packages.

These composite materials must be capable of slowing down and capturing neutrons very effectively, so as to ensure effective shielding against neutrons, on the one hand, and to maintain subcriticality within the package and/or an array of packages, on the other hand, to prevent the neutrons which form therein from causing nuclear chain reactions, in particular when the radioactive materials are fissile. In order for these composite materials to be capable of slowing down neutrons, so as to be able to subsequently capture them, they should be highly hydrogenated and they should comprise a compound, for example comprising boron, which ensures the actual capture of the neutrons.

These composite materials must also have a low density, so as to weigh down as little as possible the packages for which they are intended, and be self-extinguishing, that is to say they must stop burning as soon as the flames are extinguished. This last feature takes all its interest within the framework of the fire test relating to the accidental conditions of transport and applicable in accordance with the regulations in force to which the packages must be subjected.

The formulations allowing to obtain these composite materials must, furthermore, be able to be cast directly into a mould or into a structure forming the packages for transport, warehousing and/or storage and allow to obtain, after hardening, composite materials free of defects of the void and/or crack type so as to avoid any risk of neutron leakage.

These composite materials must also have good behaviour, or resistance, to ageing at relatively high temperatures under normal conditions of transport, warehousing and/or storage. Indeed, the presence of radioactive materials in the packages can generate high temperatures within the composite materials, typically at least 130° C., or even around 160° C. to 170° C.

Composite materials for neutron shielding and for maintaining subcriticality which are used in the nuclear industry are conventionally obtained from a polymerisable formulation comprising a thermosetting resin and an inorganic filler.

In particular, document U.S. Pat. No. 7,160,486, which is referenced [1] in the remainder of this description, describes a composite material for neutron shielding and for maintaining subcriticality which has resistance to thermal ageing at relatively high operating temperatures, it being specified that the operating temperatures correspond to the temperatures to which the packages and, consequently, the composite materials that they contain are subjected, during transport, warehousing and/or storage under the effect of the temperature of the radioactive materials they contain, which can reach 170° C.

The composite material described in document [1] is obtained from a formulation implementing a composition comprising a vinylester resin and an inorganic filler capable of slowing down and absorbing neutrons, this inorganic filler comprising at least one inorganic boron compound and at least one hydrogenated inorganic compound. In particular, the percentages by weight of vinylester resin and of the inorganic filler can be respectively comprised between 25% by weight and 40% by weight and between 60% by weight and 75% by weight, relative to the total weight of the composition.

Document U.S. Pat. No. 7,399,431, which is referenced [2] in the remainder of this description, also describes a composite material for neutron shielding and for maintaining subcriticality.

The composite material described in document [2] is obtained from a formulation implementing a composition which comprises a vinylester resin, an inorganic filler capable of slowing down and absorbing neutrons and at least one polyamide. This composition may in particular comprise from 30% by weight to 45% by weight of vinylester resin and from 10% by weight to 30% by weight of polyamide, relative to the total weight of the composition.

Experimental data show that the composite material described in this document [2] has a resistance to thermal ageing which, at operating temperatures of 160° C. and of 170° C., is slightly improved compared to that of the composite material described in document [1] and this, with a lower density.

Document JP S57 147095, which is referenced [3] in the remainder of this description, also describes a composite material for neutron shielding characterised by thermal resistance at temperatures of 150° C. as well as fire resistance.

The composite material described in document [3] is obtained from a formulation implementing a composition which comprises a halogenated unsaturated polyester resin, a polyolefin-based synthetic resin powder, a zinc borate powder and, where appropriate, aluminium hydroxide and/or antimony oxide powders. This composition may in particular comprise from 30% by weight to 80% by weight of halogenated unsaturated polyester resin, from 5% by weight to 30% by weight of polyolefin-based synthetic resin and from 8% by weight to 70% by weight of such inorganic fillers, relative to the total weight of the composition.

If the composite materials described in these documents [1] to [3] prove to be satisfactory for producing parts intended for packages for storage, warehousing and/or transport of radioactive materials and suitable for operating temperatures of 150° C., 160° C., even 170° C., it is however becoming necessary to propose composite materials which allow to withstand higher operating temperatures, in particular of the order of 180° C., and which can be maintained over time, because the durations of warehousing and/or storage of packages under air can reach forty years.

In particular, thermal ageing tests have shown that the composite material described in document [1] degrades at temperatures of 180° C. The formation of cracks within the composite material is in particular observed, such cracks being able, on the one hand, to weaken the composite material by oxidation under the effect of the oxygen of the air being able to be routed in these cracks and, on the other hand, to generate risks of neutron leakage. It is specified that the term “crack” must be understood as defining any two-dimensional or three-dimensional discontinuity visible to the naked eye.

The purpose of the present invention is therefore to overcome the formation, at temperatures of 180° C., of such cracks within a composite material and therefore to propose a composite material for neutron shielding and for maintaining subcriticality which meets all the requirements set out above and which further has particularly high-performance thermomechanical properties with resistance to ageing at operating temperatures of 180° C. to enable warehousing, storage and/or transport of loads of radioactive materials with a temperature above 160° C. or 170° C.

Another purpose of the present invention is to propose a method for manufacturing such a composite material, this method being able to be easily implemented in the equipment and tools of industrial installations currently used for the manufacture of composite materials based on thermosetting resin and in particular those implemented for the manufacture of the composite materials described in documents [1] to [3].

### DESCRIPTION OF THE INVENTION

These and other purposes are achieved, in the first place, by a composite material for neutron shielding and for maintaining subcriticality which is obtained from a particular formulation.

According to the invention, this formulation comprises:
100 portions by weight of a composition comprising, the weight percentages being based on the total weight of the composition:
   from 30% by weight to 45% by weight of a thermosetting resin selected from a polyester resin and a vinylester resin,
   from 23% by weight to 58% by weight of an inorganic filler, the inorganic filler comprising at least one hydrogenated compound and at least one boron compound, and
   from 12% by weight to 32% by weight of a polyolefin or of an olefin copolymer;
from 0.3 portion by weight to 1.4 portion by weight of a polymerisation initiator; and
from 0.3 portion by weight to 1.4 portion by weight of a polymerisation accelerator.

The composite material for neutron shielding and for maintaining subcriticality according to the invention allows to produce parts which are more particularly intended for packages for the transport, warehousing and/or storage of radioactive materials and which do not have any defects and, in particular, no cracks within their structure. This absence of cracks is observed not only at the end of the actual manufacture of these parts but also after having subjected these parts to thermal ageing tests carried out at a temperature of 180° C. The risks of degradation of the composite material by oxidation and/or of possible neutron leaks from such a composite material are thus completely eliminated. In addition, and unexpectedly and surprisingly, after these thermal ageing tests, the parts are characterised by a particularly limited surface oxidation layer which changes very little over time.

The material for neutron shielding and for maintaining subcriticality according to the invention also has the advantage of being particularly interesting from an economic point of view, the compounds used to manufacture said material being available and this, at controlled cost.

The composite material for neutron shielding and for maintaining subcriticality is obtained from a formulation which comprises 100 portions by weight of a particular composition to which are added 0.3 portion by weight to 1.4 portion by weight of a polymerisation initiator and 0.3 portion by weight to 1.4 portion by weight of a polymerisation accelerator.

This particular composition comprises:
from 30% by weight to 45% by weight of a thermosetting resin selected from a polyester resin and a vinylester resin,
from 23% by weight to 58% by weight of an inorganic filler, the inorganic filler comprising at least one hydrogenated compound and at least one boron compound, and
from 12% by weight to 32% by weight of a polyolefin or of an olefin copolymer.

It is specified that the expression “from . . . to . . . ” which has just been mentioned and which is used in the present application must be understood as defining not only the values of the range, but also the values of the limits of this range.

The thermosetting resin is selected from a polyester resin and a vinylester resin.

If the thermosetting resin can be formed by a mixture of a polyester resin and a vinylester resin, the thermosetting resin is advantageously formed either by a polyester resin or by a vinylester resin.

Preferably, the thermosetting resin is a vinylester resin. The choice of a vinylester resin allows to further improve, if necessary, the resistance to thermal ageing at high temperatures of the composite material for neutron shielding and for maintaining subcriticality obtained from a formulation comprising such a resin.

The polyester resin conventionally results from the polycondensation of at least one dicarboxylic acid or of at least one of its derivatives, such as a carboxylic acid anhydride or a diester, with an organic compound including two (glycol or diol) or more (polyol) hydroxyl groups.

In an advantageous variant, the polyester resin is unsaturated and results from the polycondensation of a dicarboxylic acid with a glycol, at least one of these compounds including an ethylenic bond capable of subsequently reacting with a vinyl, acrylic or allylic compound.

It is possible in particular to use the polyester resins obtained:
from saturated dicarboxylic acids or anhydrides, such as adipic acid, isophthalic acid, orthophthalic acid, terephthalic acid and orthophthalic anhydride, or
from unsaturated dicarboxylic acids, or anhydrides, such as maleic acid, fumaric acid, citraconic acid, metaconic acid, itaconic acid and maleic anhydride, and
glycols such as propylene glycol (propane-1,2-diol), propane-1,3-diol, dipropylene glycol, diethylene glycol, neopentyl glycol and bisphenol A, or
oxyethylated or oxypropylated glycols of oxyethylenated ethylene glycol type.

In a preferred variant, the polyester resin is not halogenated, unlike the polyester resin used in the formulation from which the composite material described in document [3] is obtained. The use of a non-halogenated polyester resin allows to limit the risks for the health of the operators and for the environment.

In a more preferred variant, the polyester resin is selected from polyester resins obtained from, on the one hand, maleic acid, isophthalic acid, orthophthalic acid or fumaric acid and, on the other hand, one of the glycols which have just been mentioned, namely propylene glycol, propane-1,3-diol, dipropylene glycol, diethylene glycol, neopentyl glycol or bisphenol A.

More preferably, the polyester resin is selected from the polyester resins obtained from:
maleic acid and propylene glycol,
isophthalic acid and neopentyl glycol,
orthophthalic acid and neopentyl glycol,
fumaric acid and bisphenol A, and
fumaric acid and propane-1,3-diol.

The vinylester resin can result from the esterification of one or more epoxy resins with an unsaturated carboxylic acid. The epoxy resin may have a macromolecular pattern of the bisphenol A type or of the novolac type. The unsaturated carboxylic acid can be selected from acrylic acid and methacrylic acid, methacrylic acid being advantageous because it is richer in hydrogen.

According to an advantageous variant, the vinylester resin is selected from the group consisting of epoxyacrylate and epoxymethacrylate resins of the bisphenol A type, epoxyacrylate and epoxymethacrylate resins of the novolac type, halogenated epoxyacrylate and epoxymethacrylate resins based on bisphenol A and mixtures of two or more thereof.

The vinylester resin can also be a non-epoxidised vinylester resin resulting from the reaction of an isophthalic polyester with a urethane.

Vinylester resins suitable for the preparation of the composition used in the context of the present invention may in particular be the vinylester resins described in documents [1] and [2] and, more particularly, the vinylester resins which correspond to the semi-structural formulas noted (I) to (IV) in document [2].

In a preferred variant, the vinylester resin comprises an epoxy resin of the novolac type.

Such vinylester resins are marketed in particular under the names Derakane Momentum™470-300 and Derakane™470HT-400 by the company Ineos.

As indicated previously, the composition comprises from 30% by weight to 45% by weight of thermosetting resin, relative to the total weight thereof.

According to an advantageous variant, and so as to optimise the flowability of the formulation with a view to its hardening, the weight percentage of thermosetting resin in the composition is from 32% by weight to 45% by weight, preferably from 35% by weight to 44% by weight, relative to the total weight of this composition.

In particular, when the thermosetting resin is a vinylester resin, optimum flowability is obtained with a percentage by weight of vinylester resin in the composition ranging from 40% by weight to 45% by weight, relative to the total weight of the composition.

The composition used in the context of the present invention also comprises from 23% by weight to 58% by weight, relative to the total weight of the composition, of a particular inorganic filler.

This particular inorganic filler comprises at least one hydrogenated compound and at least one boron compound.

The hydrogenated inorganic compound(s), whose role is to slow down the neutrons, can be selected from hydroxides and in particular from magnesium hydroxide Mg(OH)₂ and alumina hydrates Al(OH)₃ or AlO(OH).

Alumina hydrates Al(OH)₃ and AIO (OH) are more particularly preferred because these hydrogenated compounds, furthermore, confer particularly effective self-extinguishing properties to the composite material according to the invention.

The inorganic boron compound(s), whose role is to absorb neutrons once slowed down by the hydrogenated inorganic compound(s), may in particular be selected from boric acid H₃BO₃, colemanite Ca₂O₁₄B₆H₁₀, zinc borates such as 2ZnO·3B₂O₃, 3.5H₂O, 4ZnO·B₂O₃, H₂O, 2ZnO·3B₂O₃ and 3ZnO·2B₂O₃, boron carbide B₄C, boron nitride BN and boron oxide B₂O₃.

In a variant of the invention, the inorganic boron compound(s) also comprise hydrogen, which has the effect of improving the self-extinguishing properties of the composite material according to the invention. Such hydrogenated boron compounds can advantageously be selected from hydrated zinc borates such as 2ZnO·3B₂O₃, 3.5H₂O or else 4ZnO·B₂O₃, H₂O.

As already previously indicated, the composition comprises from 23% by weight to 58% by weight of inorganic filler, relative to the total weight thereof.

According to an advantageous variant, the weight percentage of inorganic filler in the composition is from 30% by weight to 50% by weight, relative to the total weight of this composition.

According to a preferred variant, the weight percentage of inorganic filler in the composition is from 32% by weight to 44% by weight, relative to the total weight of this composition.

The weight percentages of hydrogenated inorganic compounds, on the one hand, and of boron, on the other hand, can be advantageously adapted according to the properties, among the shielding and/or subcriticality properties, which are sought for the considered composite material.

In a variant of the invention, the composition comprises, relative to the total weight of this composition:
from 20% by weight to 55% by weight, advantageously from 25% by weight to 45% by weight and, preferably, from 27% by weight to 38% by weight of one or more hydrogenated compounds, and
from 3% by weight to 28% by weight, advantageously from 5% by weight to 15% by weight and, preferably, from 6% by weight to 9% by weight of one or more boron compounds.

In a particular embodiment, the inorganic filler, which comprises at least one hydrogenated compound and at least one boron compound, is in a divided form, for example in the form of granules, grains, beads, powders, flakes, . . . , which are hereafter designated by the generic term of particles.

In a particular variant, this inorganic filler is in the form of particles whose largest dimension is at most equal to 5 mm, the size of these particles being measured by laser diffraction.

This largest dimension of the inorganic filler particles can in particular be comprised between 1 μm and 1 mm, advantageously comprised between 5 μm and 500 μm and, preferably, comprised between 10 μm and 200 μm.

The composition implemented in the context of the present invention further comprises from 12% by weight to 32% by weight, relative to the total weight of the composition, of a thermoplastic polymer selected from a polyolefin and an olefin copolymer.

The polyolefin is advantageously selected from a polyethylene (PE) and a polypropylene (PP) and is preferably a polyethylene (PE).

The olefin copolymer is a polymer resulting from the copolymerisation of at least two distinct monomers, one of these monomers being an olefin monomer.

The olefin copolymer is advantageously an ethylene and vinyl acetate (EVA) copolymer.

As will be seen in the examples below, the weight percentages selected for each of the compounds forming the composition allow to prepare a formulation which, after curing, leads to the production of a composite material which meets all the requirements required for a material for neutron shielding and for maintaining subcriticality (slowing down the neutrons, capturing the latter, self-extinguishing, low density, . . . ) and which, furthermore, has an effective resistance to thermal ageing at an operating temperature of 180° C.

In particular, it should be noted that a weight percentage of polyolefin or olefin copolymer of less than 12% by weight, relative to the total weight of the composition, leads to the production of composite materials having cracks visible to the naked eye after a thermal ageing test conducted at 180° C. Similarly, a weight percentage of polyolefin or olefin copolymer greater than 32% by weight, relative to the total weight of the composition, leads to the production of composite materials which no longer meet the self-extinguishing criterion.

According to an advantageous variant, the percentage by weight of polyolefin or of olefin copolymer in the composition is from 15% by weight to 29% by weight, preferably from 16% by weight to 28% by weight, relative to the total weight of this composition.

In a variant of the invention, the polyolefin or the olefin copolymer is in the form of particles, that is to say in a divided form as described previously for the inorganic filler.

In an advantageous variant, at least 50% by number of the polyolefin or olefin copolymer particles have an average size, denoted d₅₀, ranging from 10 μm to 150 μm and, preferably, from 30 μm to 120 μm, this average particle size being measured by laser diffraction.

The composition which has just been described may also comprise, furthermore, one or more additives such as, for example, a chain limiting agent, a chain transfer agent, an agent for adjusting the rate of polymerisation of the formulation, a flame retardant agent, an antioxidant agent, a dye and/or a pigment.

The formulation allowing to obtain the composite material according to the invention comprises, for 100 portions by weight of the composition which has just been described:
from 0.3 portion by weight to 1.4 portion by weight of a polymerisation initiator, and
from 0.3 portion by weight to 1.4 portion by weight of a polymerisation accelerator.

The polymerisation initiator, whose function is to ensure the start of the polymerisation of the formulation, can be selected from organic peroxides while the polymerisation accelerator, the function of which is to accelerate this polymerisation, can be selected from cobalt salts.

The implementation of several polymerisation initiators and/or several polymerisation accelerators is entirely possible. It is however specified that the ranges of weight proportions defined above for the polymerisation initiator and the polymerisation accelerator apply, whether there is a single or several polymerisation initiators and/or a single or several polymerisation accelerators.

In particular, the implementation of two polymerisation accelerators will be illustrated in the detailed presentation of particular embodiments which follows.

The present invention relates, secondly, to a method for manufacturing a composite material for neutron shielding and for maintaining subcriticality from the formulation as described above.

According to the invention, this method comprises the following successive steps (1) to (3):
(1) preparing a composition obtained by mixing the following compounds, the weight percentages being based on the total weight of the composition:
   from 30% by weight to 45% by weight of a thermosetting resin selected from a polyester resin and a vinylester resin, the thermosetting resin advantageously being a vinylester resin,
   from 23% by weight to 58% by weight of an inorganic filler, the inorganic filler comprising at least one hydrogenated compound and at least one boron compound, and
   from 12% by weight to 32% by weight of a polyolefin or of an olefin copolymer;
(2) preparing a formulation obtained by mixing:
   100 portions by weight of the composition prepared in step (1),
   from 0.3 portion by weight to 1.4 portion by weight of a polymerisation initiator, and
   from 0.3 portion by weight to 1.4 portion by weight of a polymerisation accelerator; and
(3) moulding the formulation prepared in step (2).

The manufacturing method according to the invention is therefore a method whose implementation is particularly simple, rapid and economical. The method according to the invention allows to obtain a composite material with a shape (design) specifically adapted to the package for which it is intended. This method can, moreover, be easily implemented in the installations currently dedicated to the methods for manufacturing composite materials such as those described in documents [1] to [3].

The features described above in connection with the composition and, in particular, the features relating to the thermosetting resin, to the inorganic filler (hydrogenated and boron compounds), to the polyolefin or to the olefin copolymer, to the polymerisation initiator, to the polymerisation accelerator and to any additives, are of course applicable to this method for manufacturing the composite material.

Step (1) of the manufacturing method according to the invention, which allows to prepare the composition described above, is carried out by mixing all the compounds included in the composition, namely the vinylester or polyester resin, the inorganic filler comprising at least one hydrogenated compound and at least one boron compound, the polyolefin or the olefin copolymer, and the optional additive(s).

Step (2) of the manufacturing method according to the invention, which allows to prepare the formulation described above, is carried out by mixing the composition obtained at the end of step (1), the polymerisation initiator and the polymerisation accelerator.

The polymerisation initiator and the polymerisation accelerator can be introduced into the composition, simultaneously or else successively. In the latter case, the polymerisation initiator is then introduced last.

The mixtures made in steps (1) and (2) of the manufacturing method according to the invention can be produced manually or else by means of a mixer.

Step (3) of the manufacturing method, which allows to obtain the composite material for neutron shielding and for maintaining subcriticality according to the invention, is carried out by moulding the formulation obtained at the end of step (2).

In a first variant, this formulation can be poured into a mould.

In a second variant of the invention, this formulation can be poured directly into the package intended for the transport, warehousing and/or storage of radioactive materials. Such a package may, for example, include peripheral housings into which the formulation obtained at the end of step (2) is poured.

Step (3) of moulding the formulation as obtained at the end of step (2) is advantageously carried out at ambient temperature, that is to say that it can be carried out at a temperature comprised between 18° C. and 25° C.

At the end of this moulding step (3), during which the polymerisation of the formulation takes place, the composite material for neutron shielding and for maintaining subcriticality according to the invention is obtained.

The mechanism of this polymerisation reaction is radical.

The present invention relates, thirdly, to the use of the composite material for neutron shielding and for maintaining subcriticality as defined above, the advantageous features of this composite material being able to be taken alone or in combination.

The composite material according to the invention can in particular be used for the manufacture of a package intended for the transport, warehousing and/or storage of radioactive materials.

The invention relates, fourthly, to a package for the transport, warehousing and/or storage of radioactive materials.

According to the invention, this package for the transport, warehousing and/or storage of radioactive materials comprises a composite material for neutron shielding and for maintaining subcriticality as defined above, the advantageous features of this composite material being able to be taken alone or in combination.

Other advantages and features of the present invention will emerge more clearly from the description which follows, which relates to examples of the manufacture of composite materials in accordance with the invention and of reference materials including a composite material obtained from a composition in accordance with that described in documents [1] and [2] and two composite materials obtained from a composition of the type of that described in document [3], as well as the evaluation of their respective thermomechanical properties.

Of course, these particular embodiments of the invention are given only by way of illustration of the object of the invention and in no way constitute a limitation of this object.

### BRIEF DESCRIPTION OF THE DRAWINGS

FIGS. 1A, 1B and 1C correspond respectively to the photographic images of the plates of composite materials M2, M3 and M4′ as obtained at the end of the thermal cycle implemented to evaluate their resistance to thermal ageing conducted at 180° C.

FIGS. 2A and 2B correspond respectively to images taken by means of a scanning electron microscope (SEM) of a section of the plates of composite materials M1 and M4 as obtained at the end of the thermal cycle implemented to evaluate their resistance to thermal ageing conducted at 180° C.

### DETAILED DESCRIPTION OF PARTICULAR EMBODIMENTS

A Obtaining composite materials M1 to M8 and M4′

The formulations F1 to F8 and F4′ from which the composite materials M4, M4′ and M5 to M7 according to the invention were obtained, as well as the reference composite materials M1 to M3 and M8, were prepared from the compositions C1 to C8 and C4′ described below.

### Compounds Implemented

The compounds used for the preparation of the compositions C1 to C8 and C4′ are the following:
as a thermosetting resin:
   a vinylester resin comprising an epoxy resin of the novolac type marketed by the company Ineos under the name Derakane™ Momentum 470-300 (denoted 470-300), and
   a vinylester resin comprising an epoxy resin of the novolac type marketed by the company Ineos under the name Derakane™ 470HT-400 (denoted 470HT-400);
as polyolefin: a high density polyethylene marketed by the company Celanese under the name Gur®4050-3-PE-UHMW, denoted HDPE, which is in the form of a powder whose particles have a granulometric feature d₅₀ of 60 μm as measured by laser diffraction; and
as an inorganic filler:
   as hydrogenated compound: an alumina hydrate Al(OH)₃, denoted ATH, marketed by the company Nabaltec under the name Apyral®20X which is in the form of a powder whose particles have an average size of 8 μm as measured by laser diffraction, and
   as a boron compound: a zinc borate 2ZnO·3B₂O₃, 3.5H₂O marketed by the company Borax under the name Firebrake® ZB which is in the form of a powder whose particles have an average size of 9 μm as measured by laser diffraction.

### Preparation of Compositions C1 to C8 and C4′

The compositions C1 to C8 and C4′ were prepared by mixing a vinylester resin, the polyolefin, the hydrogenated compound and the boron compound mentioned above in the weight percentages indicated in Table 1 below.

It is specified that the composition C1 is identical to the composition of example 2 of document [1] as well as to the composition having led to the composite material called “reference material” exemplified in document [2].

The compositions C2 and C3 are compositions of the type of those described in document [3], it being however specified that the thermosetting resin implemented here is a vinylester resin and not a halogenated unsaturated polyester resin as described in this document [3].

### Preparation of Formulations F1 to F8 and F4′

The formulations F1 to F8 and F4′ were prepared by introducing and then mixing, in each of the compositions C1 to C8 and C4′, a catalytic system comprising, per 100 portions by weight of the composition under consideration:
0.676 portion by weight of a polymerisation initiator formed by a cumyl hydroperoxide marketed by the company Nouryon under the name Trigonox K-90,
0.768 portion by weight of a polymerisation accelerator formed by a cobalt (II) 2-ethylhexanoate marketed by the company Nouryon under the name Accelerator NL-49PN, and
0.192 portion by weight of a polymerisation co-accelerator formed by an N,N-diethylacetoacetamide marketed by the company Akzo Nobel under the name Promotor D.

### Obtaining Composite Materials M1 to M8 and M4′

Each of the formulations F1 to F8 and F4′ obtained was degassed under vacuum and then poured, at ambient temperature (21° C.), into a mould.

It has been observed that, although these formulations F1 to F8 and F4′ all have good flowability, the viscosity of these formulations increases with the weight percentages of polyethylene (PEHD) and of alumina hydrate (ATH).

After hardening each of the formulations F1 to F8 and F4′ at ambient temperature (21° C.) for a duration comprised between 10 min and 40 min, the composite materials M1 to M8 and M4′ were respectively obtained.

### B Evaluation of the Properties of the Composite Materials

### Thermal Ageing Resistance at 180° C.

The thermal ageing resistance of the composite materials M1 to M8 and M4′ at an operating temperature of 180° C. was evaluated by placing samples in the form of 12 cm side and 10 mm thick square plates of each of these composite materials M1 to M8 and M4′ in an oven and by subjecting them to a thermal cycle comprising the following successive steps (a) to (d):
(a) a first temperature rise from ambient temperature (25° C.) to a first plateau temperature of 80° C., at a rate of 10° C./h,
(b) a maintenance of the temperature at this first plateau temperature of 80° C. for 8 h,
(c) a second temperature rise from this first plateau temperature of 80° C. to a second plateau temperature of 180° C., at a rate of 10° C./h, and
(d) a maintenance of the temperature at this second plateau temperature of 180° C. for 24 h.

After step (d), the plates were removed from the oven and cooled to room temperature.

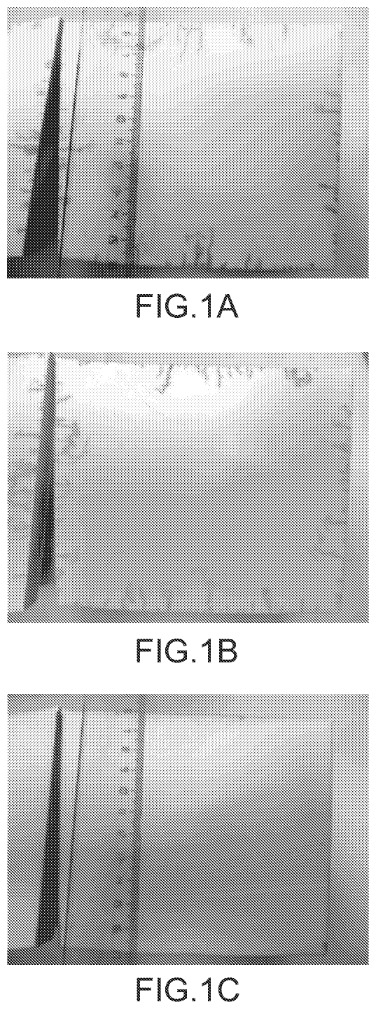

As shown by the photographs of FIGS. 1A to 1C, the composite material plates M2 (FIG. 1A), on the one hand, and M3 (FIG. 1B), on the other hand, have many cracks which are visible to the naked eye, unlike the composite material plate M4′ (FIG. 1C) which is completely devoid thereof.

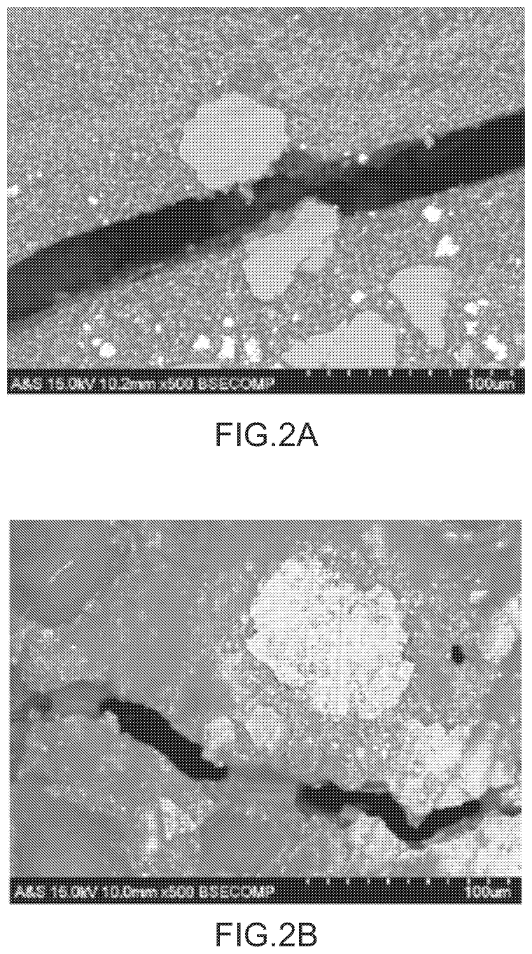

Referring to the SEM photograph of FIG. 2B, it is observed that the crack present in the composite material plate M4 is partially filled. These fillings are formed by polyethylene which is present in formulation F4 and which is melted during the thermal cycle so as to form bridges at the cracks. These bridges have the advantage of limiting the routing of oxygen of the air in these cracks as well as of preventing the propagation of these same cracks, contrary to what can be observed on the SEM photograph of FIG. 2A which shows a larger crack, and in particular wider than that of FIG. 2B, and furthermore not filled, and therefore likely to propagate, within the composite material M1 which conforms to the composite material of example 2 of document [1] and to the composite material called “reference material” described in document [2].

### Self-Extinguishability

Self-extinguishability tests were carried out on composite materials M1 to M8 and M4′ to assess their behaviour in accidental fire conditions.

These tests were carried out by placing samples of composite materials M1 to M8 and M4′ in a fire at 800° C. for 30 min. At the end of these 30 min, the flames were extinguished and it was observed whether each of the composite materials M1 to M8 and M4′ immediately or not ceased to burn.

The results of these tests, which are recorded in Table 1 below, show that the composite materials M1 to M7 and M4′ stopped burning when the flames went out, unlike the composite material M8 which only stopped burning after 32 s counted from the time the flames went out.

TABLE 1

| Composition | C1 | C2 | C3 | C4′ | C4 | C5 | C6 | C7 | C8 |
|---|---|---|---|---|---|---|---|---|---|
| 470-300 (in %) | 32 | 40 | 32 | | 40 | 40 | 35 | 35 | 40 |
| 470HT-400 (in %) | | | | 40 | | | | | |
| HDPE (in %) | 0 | 5 | 10 | 18 | 18 | 24 | 29 | 32 | 35 |
| ATH (in %) | 62 | 49 | 52 | 36 | 36 | 30 | 30 | 27 | 19 |
| Zinc borate (in %) | 6 | 6 | 6 | 6 | 6 | 6 | 6 | 6 | 6 |
| Inorganic filler (in %) | 68 | 55 | 58 | 42 | 42 | 36 | 36 | 33 | 25 |

| Composite material | M1 | M2 | M3 | M4′ | M4 | M5 | M6 | M7 | M8 |
|---|---|---|---|---|---|---|---|---|---|
| Theoretical density | 1.79 | 1.55 | 1.57 | 1.37 | 1.41 | 1.33 | 1.32 | 1.29 | 1.22 |
| (in g/cm³) | | | | | | | | | |
| Cracks to the naked eye | Yes | Yes | Yes | No | No | No | No | No | No |
| Self-extinguishability | Yes | Yes | Yes | Yes | Yes | Yes | Yes | Yes | No |

It is therefore observed that from a weight percentage of polyethylene which is greater than 32% by weight in the composition, and which is in particular equal to 35% by weight as in the case of the composition C8, the composite material M8 no longer meets at least one of the criteria of the specifications for composite materials for neutron shielding and for maintaining subcriticality, in this case that of self-extinguishability.

### BIBLIOGRAPHY

[1] U.S. Pat. No. 7,160,486 B2
[2] U.S. Pat. No. 7,399,431 B2
[3] JP S57 147095 A

What is claimed is:

1. A composite material for neutron shielding and for maintaining subcriticality obtained from a formulation comprising:
100 portions by weight of a composition comprising, the weight percentages being based on the total weight of the composition:
from 30% by weight to 45% by weight, advantageously from 32% by weight to 45% by weight and, preferably from 35% by weight to 44% by weight, of vinylester resin,
from 23% by weight to 58% by weight, advantageously from 30% by weight to 50% by weight and, preferably, from 32% by weight to 44% by weight, of an inorganic filler, the inorganic filler comprising at least one hydrogenated compound and at least one boron compound, and
from 12% by weight to 32% by weight, advantageously from 15% by weight to 29% by weight and, preferentially, from 16% by weight to 28% by weight, of a polyolefin or of an olefin copolymer;
from 0.3 portion by weight to 1.4 portion by weight of a polymerisation initiator; and
from 0.3 portion by weight to 1.4 portion by weight of a polymerisation accelerator.

2. (canceled)

3. The composite material according to claim 1, wherein the vinylester resin is selected from the group consisting of epoxyacrylate and epoxymethacrylate resins of the bisphenol A type, epoxyacrylate and epoxymethacrylate resins of the novolac type, epoxyacrylate and epoxymethacrylate resins based on halogenated bisphenol A and mixtures of two or more thereof.

4. The composite material according to claim 1, wherein the composition comprises from 35% by weight to 45% by weight and, advantageously, from 40% by weight to 45% by weight, of vinylester resin, relative to the total weight of the composition.

5. The composite material according to claim 1, wherein the composition comprises, relative to the total weight of the composition:
from 20% by weight to 55% by weight, advantageously from 25% by weight to 45% by weight and, preferably, from 27% by weight to 38% by weight of one or more hydrogenated compounds, and
from 3% by weight to 28% by weight, advantageously from 5% by weight to 15% by weight and, preferably, from 6% by weight to 9% by weight of one or more boron compounds.

6. The composite material according to claim 1, wherein
the hydrogenated compound(s) are selected from hydroxides, for example Mg(OH)₂, Al(OH)₃ and AlO(OH), the hydrogenated compound preferably being Al(OH)₃ or AlO(OH), and/or
the boron compound(s) are selected from H₃BO₃, Ca₂O₁₄B₆H₁₀, zinc borates, B₄C, BN and B₂O₃.

7. The composite material according to claim 1, wherein the boron compound(s) comprise hydrogen and are advantageously selected from hydrated zinc borates such as 4ZnO·6B₂O₃, 7H₂O or 4ZnO·B₂O₃, H₂O.

8. The composite material according to claim 1, wherein the olefin copolymer is an ethylene and vinyl acetate copolymer and the polyolefin is selected from a polyethylene and a polypropylene, the polyolefin preferably being a polyethylene.

9. The composite material according to claim 1, wherein the polyolefin or the olefin copolymer is in the form of particles, these particles advantageously having an average size in number d₅₀ ranging from 10 μm to 150 μm and, preferably, from 30 μm to 120 μm.

10. A method for manufacturing a composite material according to claim 1, this method comprising the following successive steps (1) to (3):
(1) preparing a composition obtained by mixing the following compounds, the weight percentages being based on the total weight of the composition:
from 30% by weight to 45% by weight of a vinylester resin,
from 23% by weight to 58% by weight of an inorganic filler, the inorganic filler comprising at least one hydrogenated compound and at least one boron compound, and
from 12% by weight to 32% by weight of a polyolefin or of an olefin copolymer;
(2) preparing a formulation obtained by mixing:
100 portions by weight of the composition prepared in step (1),
from 0.3 portion by weight to 1.4 portion by weight of a polymerisation initiator, and
from 0.3 portion by weight to 1.4 portion by weight of a polymerisation accelerator; and
(3) moulding the formulation prepared in step (2).

11. The manufacturing method according to claim 10, wherein step (3) of moulding is carried out at a temperature comprised between 18° C. and 25° C.

12. A use of a composite material for neutron shielding and for maintaining subcriticality according to claim 1 for the manufacture of a part of a package intended for the transport, warehousing and/or storage of radioactive materials.

13. A package for the transport, warehousing and/or storage of radioactive materials comprising a composite material for neutron shielding and for maintaining subcriticality according to claim 1.
